(19) United States
(12) Patent Application Publication
(10) Pub. No.: US 2012/0126972 A1
(43) Pub. Date: May 24, 2012

(54) Ruggedized control glove allowing dynamic balance and undivided visual attention

(76) Inventors: Dainuri Rott, Palo Alto, CA (US); Paul Edwards, North Vancouver (CA)

(21) Appl. No.: 13/303,090

(22) Filed: Nov. 22, 2011

Related U.S. Application Data
(60) Provisional application No. 61/416,223, filed on Nov. 22, 2010.

(30) Foreign Application Priority Data
Nov. 22, 2011 (US) PCT/US11/61948

(51) Int. Cl. G08C 17/02; G08B 1/08

(52) U.S. Cl. 340/539.11; 340/12.5

(57) ABSTRACT

Various embodiments of a wireless control glove are optimized for use with powered rideable boards, mobility devices, or remote-controlled (RC) models. Incremental, “analog-like” throttle control takes full advantage of the nuanced power variability provided by electric motors. The control glove can be operated one-handed, by touch alone, in any body position, yet the input transducer placement prevents accidental commands. An output transducer on the glove provides alerts on power-reserve (e.g. battery) status. The alerts are detectable either by touch alone or a quick glance with peripheral vision.

### RELATED APPLICATIONS

This application claims priority from U.S. Provisional App. No. 61/416,223, filed Nov. 22, 2010. It is co-pending with PCT/US11/61948, filed Nov. 22, 2011.

### FEDERALLY SPONSORED RESEARCH AND DEVELOPMENT

None

### APPENDICES

None

### BACKGROUND

Related fields include touch-sensitive switches and the wireless remote control of electric motors.

Compared to combustion-based motors, electric motors are quieter, produce no exhaust product, present a far lesser fire hazard, and may be charged using solar cells in remote locations far from any fuel source. Improvements in batteries and other technologies have made cordless electric motors much more compact, lightweight, powerful, capacious, and efficient than ever before. As to the user interface that controls or monitors the motor, one size does not fit all. Specialized applications such as rideable boards, remote-controlled models and toys, and mobility-assisting devices each impose particular constraints on the nature of the interface.

“Rideable-board” recreational devices such as surfboards, skateboards, snowboards, and sailboarders can increase their range, speed, and versatility in different environments if powered by motors that do not detract from their aerodynamic and hydrodynamic properties or their maneuverability. Electric motors have more flexibility of configuration for these applications because they have no fuel lines or sloshing liquid. Their quiet, odorless operation has much less negative impact on passersby and wildlife than combustion engines. Importantly, they respond much more quickly and accurately to the kind of nuanced speed-variation commands necessary to catch a wave, work with gusting winds, or share space with non-stationary obstacles such as other people, animals, and moving objects.

The above rideable boards, as well as some other rideable devices, lack gas-pedals, hand-throttles, handlebars, or steering wheels. In the original unpowered versions, motion and acceleration are provided by pushing, paddling, gravity, wind, current, or waves, and steering is done by the user's body movement. Once a motor is added, the user needs to control the motor, even if only to turn it on and off. Adding a column for a hand-operated throttle or steering apparatus would radically change the nature of the user's experience (for instance, a skateboard would become a scooter, which handles very differently and demands less “whole-body” engagement). Wires and cables attached to controls in these settings would be vulnerable to disconnection or breakage, either while using or transporting the rideable board, or could impede the user's freedom of movement to a frustrating or even dangerous degree.

Moreover, rideable boards are often used in highly dynamic environments, which impose restrictions on the power-drive's rider-interface. First, riders need to constantly adjust their balance, often using both arms and both legs. Therefore, controls requiring a specific position of the rider's hands (such as a wrist strap, ankle strap, harness, or vest) or feet (such as a pedal or pressure plate mounted to the surface of the board) are sub-optimal because the position needed for control may in some situations compromise balance. Second, the rider needs to constantly monitor the surroundings to see emerging hazards in time to avoid them. Therefore, controls requiring the rider to look down and refocus on something small and relatively near, such as a selector or visual monitor, would be distracting and could be dangerous. Third, the riding activity is often surrounded by fairly loud broad-spectrum audible noise (waves, friction of snow, wind in a sail, wheels on pavement). Therefore, voice commands and audible feedback signals may not always work reliably. Fourth, unintentional activation of a throttle or steering control can throw the rider off the board, possibly injuring the rider or damaging the board. Therefore, precautions should be taken to prevent the controls' activation by involuntary movements of the rider's body. Fifth, some falls or bumps will be unavoidable no matter what, and the transportation of the equipment is often ungentle. Therefore, the controls should not be vulnerable to shocks, or to gadget-hostile environmental factors such as water, salt, snow and ice, or dirt.

Remotely controlled motorized models and toys are sometimes operated under conditions similar to board-riding environments. The operator's balance is usually not an issue. However, particularly in races or battles, collisions can result from looking away from the operation theater even for a moment, or from unintentionally activating a control; the environment can be very noisy; and ruggedness is important because many operators travel significant distances to events.

Rideable mobility devices such as wheelchairs and scooters also benefit from motorization, which gives the rider more choices than either developing superior upper body strength or hiring someone to push. Compared to fuel-burning motors, electric motors are quieter, smoother, and safer, and their lack of toxic or unpleasant emissions is strongly preferred by both riders and bystanders. The constraints on mobility rider-interface design vary with the abilities of the rider; a joystick or trackball works well for some, but others find them uncomfortable or even impossible to maneuver.

Commands common to all three of these applications include, but are not limited to (1) power on and off; (2) accelerate and decelerate; (3) cruise at the present speed, and (4) steer (this includes vertical adjustment for capable devices). Monitoring needs include, but are not limited to (1) urgent low-battery warning, (2) operating time left at present speed before battery depletion, (3) present speed, and (4) present direction of travel. (1) and (2) are particularly important with electric motors because charge depletion is proportional to velocity-cubed. In board-riding sports, remote-controlled model events, or use of mobility devices, an unexpected power failure can be highly inconvenient, expensive, or even dangerous. But even where the downside risk is low, the fact that reducing the speed by half increases the operation time by a factor of 8 makes user control of the trade-off between speed and operation time very desirable.

Hand-wearable wireless control devices have been developed for transmitting data to computers and video games by touch, gesture, or both. They are generally not ruggedized or waterproof. They are fairly unidirectional, since their users are always facing toward the computer or game they are controlling. They are highly sensitive and deliver extremely fast responses, which are ideal for computers and games being used indoors by a substantially stationary user. However, “hair-trigger” operation may be undesirable where the controlled device responds on a slower scale, as a motor does, and sending an unintentional signal by an inadvertent hand movement could cause an accident.

Some ruggedized wireless hand-worn controllers for motors have been developed, but are either too cumbersome or too complex for board-riding sports. Here again, one common shortcoming is the need for the operator to change body position or visual focus to use the controller. Another is that motions used to activate the controllers are ones commonly made involuntarily when startled anxious, or excited, in efforts to keep one's balance, to ward off obstacles, and other common situations encountered in dynamic environments. Such motions include making a fist with the thumb inside, throwing the palm forward with the fingers spread, and grabbing a nearby object. Any of these hand movements, involuntarily made in response to a surprise, can destabilize a rider of an unpowered board. If that same involuntary gesture additionally issued a command to change the speed or direction of a motorized board, falls and collisions would become more likely and cause more damage when they occurred.

Therefore, a need exists for a wearable interface to wirelessly control the power, speed, and direction of an electric motor and monitor battery usage, while allowing the user to be in any comfortable or balanced body position in a wide range of orientations relative to the motor's receiver, and do not require the user to look away from the surroundings. This wearable interface should be configured to ignore movements of the user's body that are inadvertent or not intended to transmit a command to the motor. In some applications, ruggedness, shock resistance, and imperviousness to mechanical shock, water, salt, dust, and hot or cold climates are also desirable. The ability to adjust the sensitivity of the interface to fit the skill level of the user or the degree of challenge presented by the location would be convenient as well.

### SUMMARY

Wireless control of an electric motor while preventing unexpected loss of power is provided by a control glove with a lightweight wireless transmitter and receiver communicating with a corresponding receiver and transmitter attached to the device being controlled.

Prevention of accidents that may damage persons or property is achieved by a control glove with safeguards against the sending of involuntary signals.

Effective operation where multiple influences compete for a user's coordination and attention is accomplished by a control glove's transmission of commands by natural user movements, which movements rapidly become intuitive and accommodate any position or position shift a user might take to maintain balance. Important warning signals that are either delivered by tactile sensations or very simple visual changes easily detected by peripheral vision, also contribute to the minimization of user distraction.

Flexibility to operate optimally for users of different skill levels in differently demanding environments is provided by a control glove's adjustable sensitivity.

Smooth control of speed and direction of an electrically motorized device is attained by a control glove that can vary the related command signals either continuously or in such small increments that the user perceives the variation as continuous.

Robustness in transport and use in challenging operating environments is provided by ruggedizing a control glove against any combination of compression, shock, abrasion, water, salt, dust, and hot or cold ambient temperature typical of each specific application.

### BRIEF DESCRIPTION OF THE DRAWINGS

FIG. 1 shows how an example of how a control glove could be used by a surfer to control a powered surfboard.

FIG. 2 conceptually illustrates features and functions common to many control-glove embodiments.

FIGS. 3a-3c demonstrates a few different types of touch-sensitive slider controls that could be mounted in a control glove.

FIG. 4 illustrates a control glove that leaves the thumb and fingertips free, with some examples of alternative control configurations.

FIGS. 5-7 show control glove embodiments with various transducer locations.

FIGS. 8a, 8b and 9 show examples of convenient “on/off” switch positions on a control glove.

FIG. 10 shows a configuration of input transducers allowing two variables to be controlled simultaneously and independently.

FIGS. 11a-d illustrate the use of a combined throttle and steering transducer mounted on a single finger.

### EMBODIMENTS

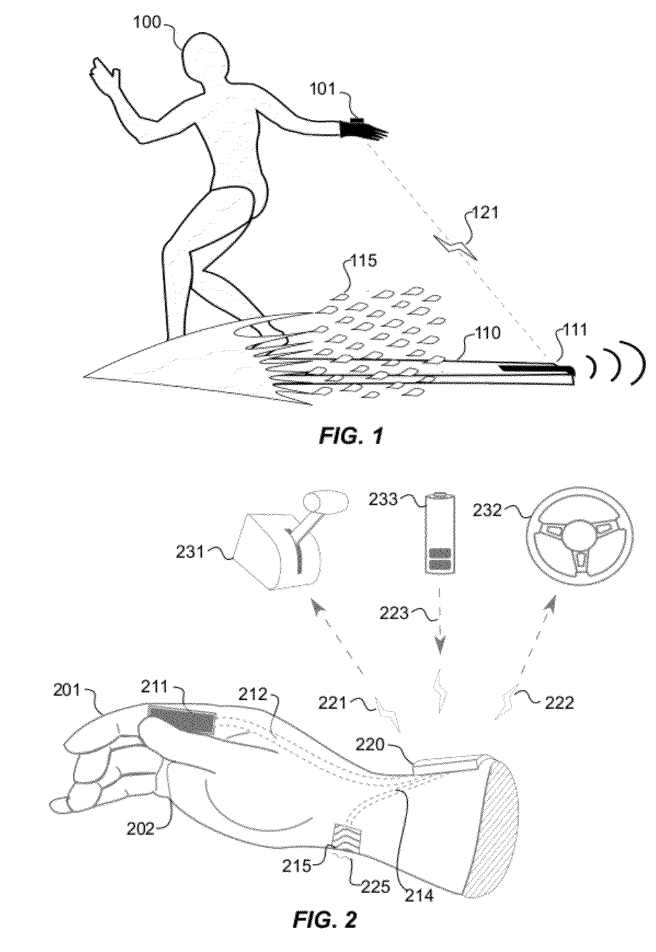

FIG. 1 shows an example of a ruggedized control glove in action. User 100 wears control glove 101 to control motor 111 in motorized surfboard 110 via wireless signal 121. User 100 needs to use his or her entire body to maintain balance on surfboard 110 on the constantly changing surface of the water while coping with distractions such as splash 115. Therefore, glove 101 is configured to communicate with motor 111 regardless of the position of User 100's body and arms, and through any splash 115. Also, preferred embodiments of glove 101 enable user 100 to enter at least the most commonly used motor commands using only the hand wearing glove 101. In addition, if motor 111 is a finely controllable (e.g. electric) motor, glove 101 includes a transducer providing incremental power control to take advantage of the continuous or quasi-continuous power variability.

User 100 needs to be warned if the motor is about to lose power, for example if the battery charge is depleted. Therefore, glove 101 communicates with a power monitor (not shown) and notifies user 100 about remaining power reserves. User 100 also needs to dedicate both forward and peripheral vision to his or her surroundings to detect and avoid rocks, flotsam, tangles of seaweed, and other people or sizable animals nearby. Therefore, glove 101 is configured to perform its main in-motion functions without requiring user 100 to see it, or at most requiring a brief peripheral glance.

The environment of FIG. 1 is an example of a noisy environment where audio signals might not be heard. Therefore, in preferred embodiments, glove 101 delivers alerting signals by touch or easily-readable sight. User 100 may fall off surfboard 110; in that event, glove 101 is preferably configured to shut off motor 111. Finally, to survive both the use environment and the transportation, glove 101 is preferably configured to be impervious to water, salt, sand, mechanical shock, temperature cycling, tension, and compression. The electronic components in glove 101 may be embedded in, or covered by, materials such as polychloroprene (aka Neoprene), polypropylene, and other elastomers and foams suitable for marine use.

Other applications impose different constraints. For example, a glove for a mobility device might not need to withstand total immersion in salt water, but is preferably impervious to rain or snow. Further, a glove to control a mobility device is preferably lightweight and comfortable for all-day wear. Such a glove could be made of a breathable material similar to those used in driving gloves, with the solid components such as the power source distributed for optimal ergonomic comfort. Some embodiments of a mobility-device control glove have multiple redundant transducers in different places to prevent repetitive-motion damage to the hand. By contrast, a glove for RC model control might be configured with lightweight breathable material for warm-weather wear, but include a removable over-glove for cold weather.

FIG. 2 conceptually illustrates some basic control-glove functions common to many applications. The wearer of glove 201 generates commands by tapping or sliding thumb 202 against position-sensitive input transducer 211, which is positioned facing the thumb along the proximal phalanx of the index finger. The incremental sliding capability takes full advantage of the nuanced power control possible with electric motors. Such fine control is a boon to a surfer catching a wave, a snowboarder or skateboarder dodging obstacles at speed, or a mobility-device user maneuvering in a crowd.

The signal input by the user to input transducer 211 travels through command conduit 212 to transceiver 220, which translates it to wireless command signals. In this example, throttle command signal 221 controls acceleration apparatus 231, and steering command signal 222 controls steering apparatus 232. Command signals 221 and 222 are preferably keyed to a specific motor's on-board wireless transceiver (not shown here), to control only the glove-wearer's motor and not that of any nearby similarly-equipped motors. This precludes multiple co-located users from interfering with each other's devices. While the motor is powered on, battery monitor 233 monitors the power remaining in the motor's battery and transmits a corresponding monitor signal 223 through the on-board wireless transceiver back to glove transceiver 220. On receiving a signal such as a low-battery warning, glove transceiver 220 activates output transducer 215 through monitor conduit 214. Output transducer 215 is shown here as a haptic transducer (e.g. a compact vibrator) positioned on the inside of the wrist, where the skin tends to be sensitive to tactile stimulation 225.

Note that the position-sensitive input transducer can issue a command by moving only the thumb, leaving the rest of the body free to maintain balance or react to changing elements in the environment. Commands can also be issued without looking at the glove. Yet, touching the thumb to the forefinger is not a common inadvertent motion (unlike spreading the fingers or making a fist with the thumb over the distal interphalangeal joints), so commands are highly unlikely to be issued unintentionally. In some embodiments, the absence of a touch on the input transducer can act as a “dead-man” switch to turn the motor power off. The haptic alerting system brings a low-battery condition to the user's attention without requiring the user to look at the glove or hear an audible alarm above the ambient noise.

The variables that may be changed in different embodiments of the control glove to optimize the design for particular applications are (1) the design of the glove body, (2) the types of transducers, (3) the locations of transducers, (4) the choice of the hand motions that issue the various commands, and (5) the ruggedizing measures. These variables are substantially independent of each other; although a limited number of examples are illustrated here, their features may be “mixed and matched” without exceeding the scope of the claimed subject matter.

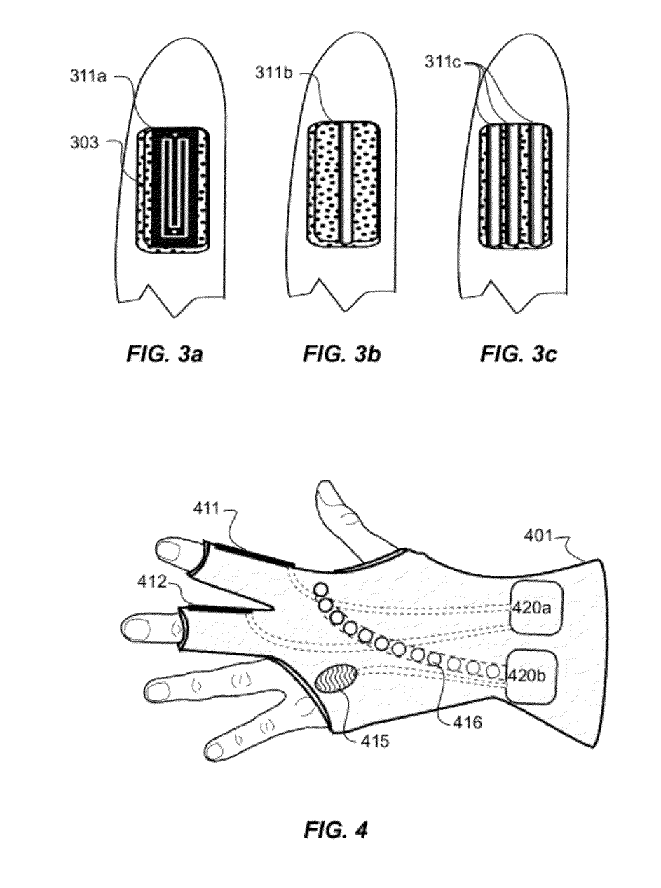

FIGS. 3a, 3b, and 3c conceptually illustrate different types of input transducers, as well as an alternate placement near a distal phalanx of a finger or thumb. These are cut-away views exposing the sensors for illustration; in most embodiments, the sensors would be sealed inside the structure of the glove for protection. Here, the glove material 303 is shown as a spongy material that may be waterproof or breathable as preferred for the intended use. Example transducer 311a is a capacitive strip similar to those used in electronic musical instruments, and may be sensitive to touch position in one or two dimensions. These can generally only bend in one direction, which needs to be taken into account when positioning them on a glove. Example transducer 311b is a single touch-sensitive wire that changes conductivity, either depending on where it is touched or how far it is stretched. These can bend in any direction, but may in some situations be hard to “find” by touch alone. Multiple touch-sensitive wires 311c can provide a compromise between flexibility and inaccuracy-forgiveness, or provide position sensitivity in two dimensions by comparing the signals in the separate wires.

One non-limiting example of a presently available line of touch-sensitive switches is the CapSense® product family made by Cypress Semiconductor of San Jose, Calif. USA. Some models are hermetically sealed, some can be programmed with advanced mixed-signal applications, and some can interface with gyroscopes. However, those skilled in the art recognize that any type of touch-sensitive transducer with suitable capabilities may be used in this type of glove. Pressure or proximity sensitivity may be added to touch position and touch duration to enable a wider variety of commands. Some sensors can discern the touch or close proximity of a human finger from that of general inanimate objects. In some embodiments, such a sensor could guard against accidental activations—for example, an input transducer being bumped when gear is being loaded, unloaded, or cleaned—by “gating” all of the other functions: if a human hand is not sensed inside the glove, glove power is conserved and touches on the outside of the glove are ignored.

In applications where the hands need more protection, such as skateboarding and snowboarding, a full-coverage glove as in FIG. 2 is desirable. Knuckle guards and wrist reinforcement may also be desirable for skateboarders, and active warming or passive warmth-retention measures for snowboarders. However, a cut-away design like that in FIG. 4 may be preferred by hot-weather surfers and others who want to minimize the feeling of wearing a glove.

FIG. 4 shows an example of a partial glove 401 that leaves the thumb and fingertips free while preventing slippage that could cause the input transducer to “wander” around on the hand. Partial glove 401 has a first touch-sensitive input transducer 411 on the side of the index finger and a second touch-sensitive transducer 412 on the side of the middle finger. Second touch-sensitive transducer 412 is addressed by moving the index finger out of the way and tapping or sliding with the thumb. Multiple transducers can control different functions of the device being used; for example, power on/off and acceleration, or acceleration and steering, or acceleration and cruise control on/off.

In the illustrated embodiment, the transceiver function is split into transmitter 420a and receiver 420b, which may distribute weight and bulk more comfortably on the wrist in some situations. This embodiment has two output transducers: haptic element 415 between the ring-finger and pinky knuckles, another relatively sensitive part of the hand, and visual indicator strip 416. Preferably, visual indicators for these control gloves are noticeable in peripheral vision or with a quick glance. Indicator 416 is shown here as a strip of lights (e.g. light-emitting diodes). It extends substantially over the entire back of the hand and is therefore easy to see. The number of lights illuminated may correspond to the power left in the battery, or different-colored or color-changing lights may be used. Alternatively, a strip or patch of electrochromic material may be used: for instance, it may be green when the battery is fully charged, and red when near depletion. When power depletion is imminent, haptic element 415 goes off to notify a user who might have been too preoccupied to look at the visual indicator.

This configuration is particularly convenient for sailboarders because they can thumb-address transducer 411, or move the index finger to thumb-address transducer 412, and easily feel signals from transducer 415, while continuing to firmly grasp the boom with at least three fingers of the gloved hand if needed.

In alternate embodiments, input transducer 411 or 412 may be, or be combined with, a suitable output transducer. In any embodiment, output transducers may be co-located under or near the input transducers to simplify construction and make double use of “safer” parts of the hand where accidental impacts are less likely.

In applications such as board-riding or use of a power-optional mobility device, a user who becomes aware of a low-battery condition may elect to continue use in unpowered mode for a while before changing or recharging the battery. Embodiments for these applications may include a shutoff command the wearer can send to end the tactile sensation or preserve the glove's internal battery power.

A more complex output system might have a series of output transducers placed in some logical configuration, such as in a line across the back of the hand or along the back of a finger. In one embodiment, the closer the battery is to needing a change or recharge, the more of the transducers activate. In another embodiment, the number of active output transducers is inversely proportional to the time remaining on the battery at the present speed. No output transducers are activated until the remaining time is some predetermined threshold, such as 30 minutes or 15 minutes. When the wearer increases speed, more transducers activate and the signal becomes more urgent as the remaining time decreases. When the wearer decreases speed, some of the output transducers deactivate; when the speed decreases to a point where the remaining time is greater than the predetermined threshold, all of them deactivate until the threshold is reached again.

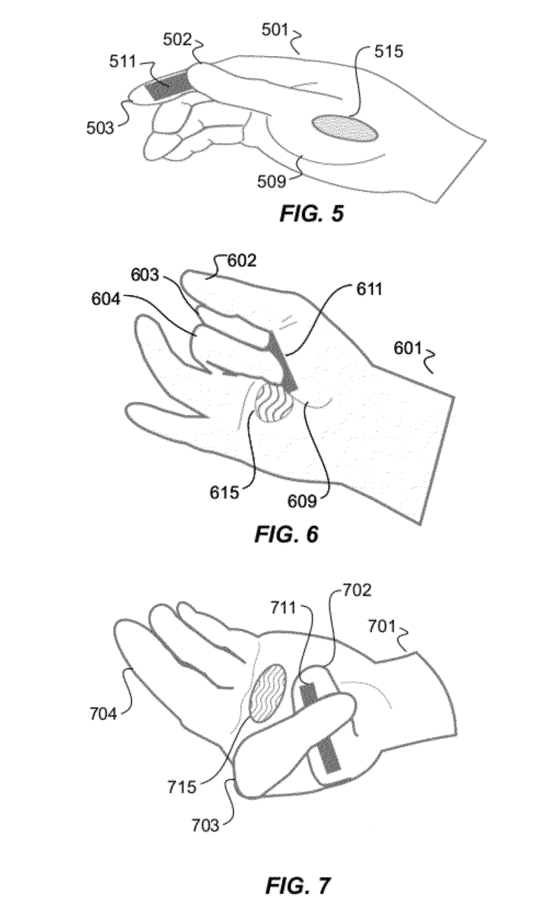

FIGS. 5, 6, and 7 illustrate a few (though not all) other positions for input and output transducers. These examples are not limiting and the positions of the input and output transducers are independent of each other.

In FIG. 5, glove 501 has touch-sensitive input transducer 511 along the side of the middle and distal phalanges of index finger 503, operated by thumb 502. Output transducer 515 is placed on the side of the hand adjacent to thenar pad 509. In FIG. 6, glove 601 has touch-sensitive input transducer 611 on the edge of thenar pad 609 and thumb 602, operated by index finger 603, middle finger 604, or both. Output transducer 615 is in the center of the palm. In FIG. 7, glove 701 has touch-sensitive input transducer 711 on the outside of thumb 702, operated by index finger 703, middle finger 704, or both. Output transducer 715 is near or on the palmar digital crease.

All these input transducers are unlikely to be activated accidentally, as the normal involuntary fist-clench motion drives the fingertips into the proximal palmar crease and curls the thumb over the outside of the fingers. All these output transducers are near relatively sensitive areas of skin (for haptic transducers) and easy to glance at peripherally (for easy-read visual transducers).

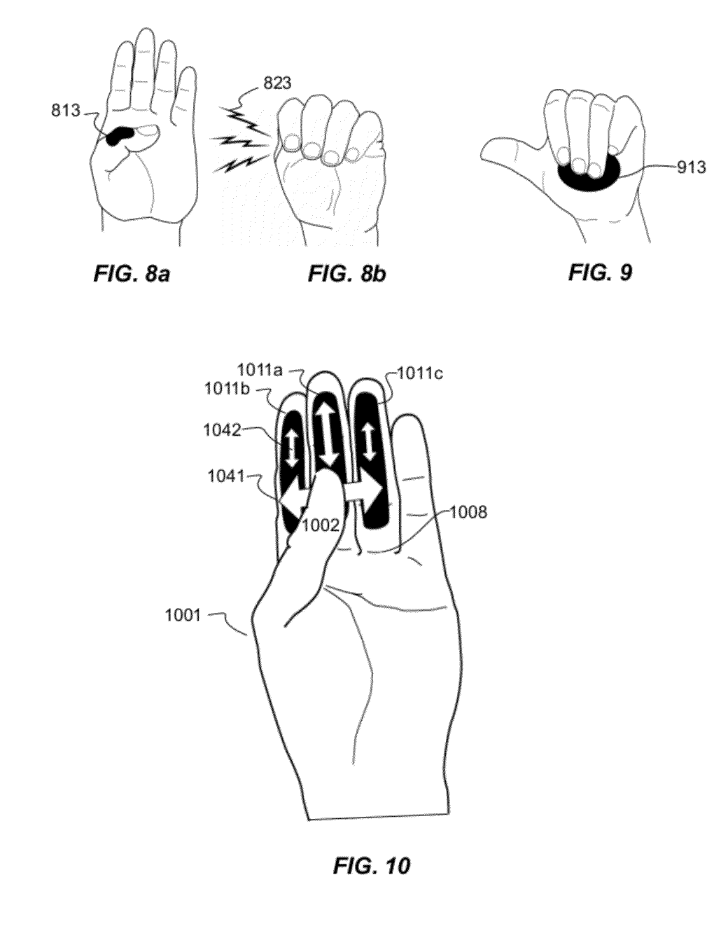

FIGS. 8a, 8b and 9 show some additional locations for on/off controls for, by way of non-limiting example, motor power, alert signals, or constant-velocity cruise control, which can be highly convenient. In FIG. 8a, on/off control 813 is on the distal interphalangeal joint of the thumb, but could equivalently be placed entirely on the distal phalanx near the tip. In FIG. 8b, the fingers toggle the controlled function on and off by squeezing the thumb with the fingers to produce command signal 823. Multiple squeezes in rapid sequence can be used to send different signals. Because the thumb must be inside the fingers to send a signal, accidental activation will not occur by the involuntary type of thumb-outside fist clench. FIG. 9 shows on/off control 913 near the heel of the hand, such that the distal interphalangeal joints of the fingers must be consciously kept straight to activate it. An involuntary fist-clench bends the distal interphalangeals, and control 913 can be sized and positioned to be unreachable in that situation.

In board-riding and RC model control, simultaneous control of steering and throttle is highly advantageous, sometimes absolutely necessary. One approach would be to use two gloves, one for steering and one for throttle. FIG. 10 shows another approach using a single glove with touch-sensitive input transducers 1011a, 1011b and 1011c on the insides of the index, middle, and ring fingers of glove 1001. Thumb 1002 can move across the input transducers in directions 1041 by adjusting the bending of its own joints. Bending palmar digital joints 1008 allows thumb 1002 to travel toward and away from the fingertips in directions 1042. The command signal depends on the position of touch on each of transducers 1011a, 1011b, and 1011c. In one embodiment, throttle is controlled by moving thumb 1002 in direction 1042, and steering by direction 1041. The most intuitive configuration would be toward the fingertips for more speed, toward the palm for less, toward the index finger to turn left, and toward the ring finger to turn right (for a right-handed glove with the palm facing down; left handed gloves would have the steering commands reversed).

In FIG. 10, thumb 1002 is shown touching middle transducer 1011a, closer to the palm than the fingertip. In the embodiment described above, this would correspond to traveling straight forward at a moderately slow speed. To turn right at the same speed, thumb 1002 would slide straight over toward transducer 1011c in direction 1041. The sharpness of the turn would be determined by the extent of the thumb motion, being sharpest when the thumb moves all the way to the outer edge of transducer 1011c. To straighten out in the new direction, thumb 1002 would go back to the illustrated position. If the user wanted to accelerate while still turning right, thumb 1002 would move toward or onto transducer 1011c AND toward the fingertips. The path taken by thumb 1002 could be straight or curved, allowing much nuanced control of both variables simultaneously.

Some touch-sensitive input transducers react if touched by anything, while others only react if touched by an object with certain electrical, mechanical, or thermal characteristics, and still others must be touched by a corresponding sensor. All these types of transducers may be used in various embodiments of a control glove. In many cases the touched-by-anything sensors are optimal for low cost, simplicity, and versatility. However, in some situations more selective transducers are desirable. Suppose, for example, glove 1001 controlled a powered surfboard. Surfers often have occasion to grasp the edges of their boards: while paddling, rising to a standing position, or waiting for the right wave. If the touch of the edge of the board on transducers 1011a, 1011b and 1011c accidentally sent commands to the motor, inconvenience and perhaps even danger could result. Using transducers that only activate if touched by a corresponding sensor for 1011a-c, and positioning the corresponding sensor on the side of thumb 102, would greatly decrease the risk of accidental activation. The FIG. 9 glove could also benefit from requiring that transducer 913 only be activated when touched by corresponding sensors embedded in one or more glove fingertips, if the application is expected to include grasping objects in the fist or putting weight on the palm while the glove is in use.

Programmable sensitivity of the input transducers is contemplated for some embodiments, allowing the glove to adapt to users with various levels of dexterity and experience. The sensitivity of the output transducers may also be programmable, for instance if battery swapping or charging takes longer to access in some locations than in others.

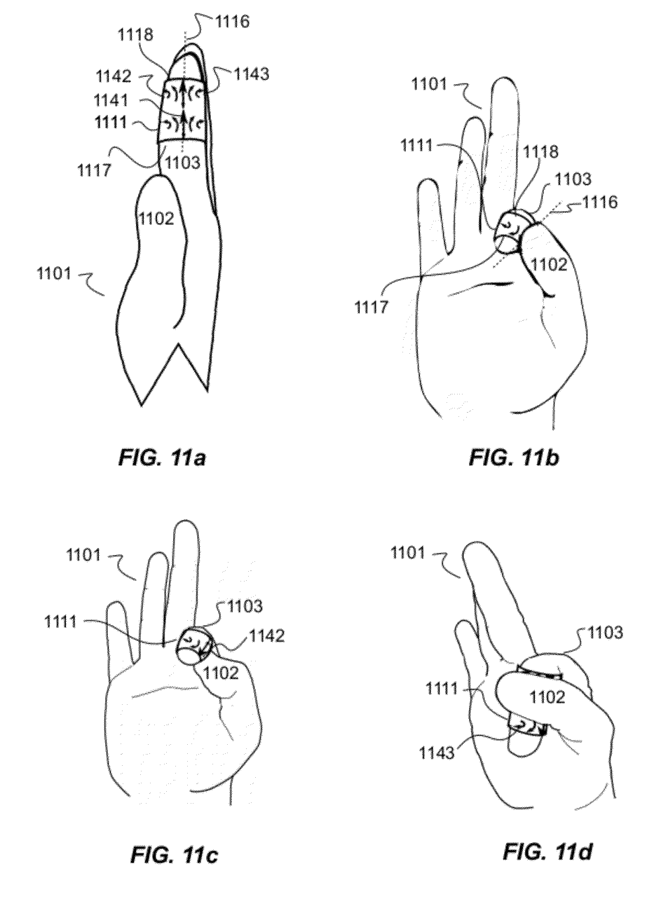

FIGS. 11a-d conceptually illustrate an independent-throttle-and-steering embodiment particularly suitable for programmable sensitivity. Glove 1101 has an input transducer 1111 on index finger 1103 that may partially or completely wrap around the finger. In FIG. 11a, note that the position of transducer 1111 toward the tip of finger 1103 prevents thumb 1102 from accidentally “bouncing” against the transducer when the hand is relaxed. This transducer 1111 is position-sensitive, using axial motion 1141 for throttle control and lateral motions 1142 and 1143 for steering to the left and right, respectively. The lateral center axis 1116, corresponding to straight-ahead motion with variable throttle but no steering, lies on the thumb-ward side of index finger 1103, where thumb 1102 most readily lands when the hand partially curves to engage the transducer, Transducer 1111 may be a single position-sensitive element or an array of elements. In FIG. 11b, the thumb is on the axis 1116 of transducer 1111, about three-quarters of the way toward proximal edge 1118. This corresponds to traveling straight ahead at medium-low speed. To accelerate, the wearer would slide thumb 1102 along axis 1116 up toward distal edge 1117. In FIG. 11c, the wearer turns left by sliding thumb 1102 under index finger 1103 onto lateral motion section 1142. In FIG. 11d, the wearer turns right by sliding thumb 1102 over index finger 1103 onto lateral motion section 1143. The further thumb 1102 moves laterally, the sharper the turn; the further thumb 1102 is toward the fingertip, the more power goes to the throttle.

For safety, a very simple signal, such as a single tap anywhere on the transducer, can shut off the motor. Double and triple taps, and taps on different parts of the transducers, can also correspond to different commands. For example, a double tap might activate cruise control at a speed corresponding to the position of the double tap. Pressing and holding anywhere on the transducer can turn the motor on at a throttle level corresponding to the position being pressed; from there, sliding can control acceleration and deceleration.

The time interval distinguishing, e.g., a double-tap command from two consecutive single-tap commands can be programmable to match the wearer's dexterity and preference. The top speed and sharpest turns enabled by the transducer may also be programmable. For instance, a beginner may enable only moderate speeds and gentle turns while learning to use the glove and the thing it controls. As the wearer's skill and comfort improve, she may elect to enable higher speeds and sharper turns. An instructor may wish to reduce glove sensitivity when teaching beginners so that his control motions are exaggerated and thereby easier for the students to see. When class is over, the instructor may reset the glove to high sensitivity and control the device with very fine motions for advanced performance.

Some embodiments may include onboard data storage: for instance, power usage over time. Viewing the data, with or without correlation to film, global-positioning data, or tide information allows the user to review when the most power was used and plan how to optimize power use on future occasions.

The range of protected variations of this subject matter is limited only by the scope of the appended claims, not by this description or the accompanying drawings.

We claim:

1. A control-glove system comprising:
a glove,
a touch-activated input transducer attached to the glove,
a wireless transmitter attached to the glove, configured to receive input from the input transducer and transmit corresponding throttle or steering commands,
a control module attached to a motorized device, receiving the commands from the transmitter and responsively controlling the motorized device,
a monitor attached to the motorized device sensing a status of the motorized device and emitting a corresponding status signal,
a wireless receiver attached to the glove, configured to receive the status signal, and
an output transducer attached to the glove and controlled by the receiver to emit an alert dependent on the status signal;
where
the input transducer is configured to produce input from deliberate gestures by a part of a hand wearing the glove, without requiring contact with another object or another part of a wearer's body,
the input transducer is further configured to avoid producing input from an involuntary reaction of the wearer, and
the alert is perceptible and comprehensible by the wearer whether or not the wearer focuses vision on the output transducer.

2. The system of claim 1, where the glove exposes a thumb or at least one finger of the hand wearing the glove.

3. The system of claim 1, where the input varies with at least one of touch position, touch duration, and touch pressure.

4. The system of claim 1, where the input transducer is activated by motion of a thumb, finger, or combination of thumb and finger, of the hand wearing the glove.

5. The system of claim 1, where the input transducer is capable of varying the input by three or more nuanced increments.

6. The system of claim 1, where the input transducer is configured to avoid unintentional activation by bumping or compression against other objects while not being worn on the hand.

7. The system of claim 1, where the control module controls a throttle function or a steering function of the motorized device.

8. The system of claim 7 where commands for full throttle or acute steering require less-comfortable hand gestures or positions than commands for low throttle or gradual steering.

9. The system of claim 1, where the control module causes the motorized device to stop or idle if a signal strength from the transmitter is lost or becomes excessively weak or intermittent.

10. The system of claim 1, where the monitor senses an amount stored energy remaining in a power source for the motorized device, and causes the alert in the output transducer when alert when the amount falls below a threshold.

11. The system of claim 1, where the output transducer comprises at least one of a haptic transducer,
an audio generator, and
a visual display with states distinguishable by the wearer's peripheral vision.

12. The system of claim 1, where the glove, input transducer, output transducer, transmitter, receiver, or a connection therebetween is ruggedized to withstand at least one of
mechanical shock,
mechanical abrasion,
immersion in water, and
immersion in brine.

13. A method of controlling a motorized device, the method comprising:
actuating an input transducer on a glove by moving a finger or thumb of a hand wearing the glove, and
receiving information about a status of the motorized device through touch, hearing, or peripheral vision while operating the motorized device from an arbitrary bodily position and visually focusing on the motorized device or a surrounding environment,
where
a wireless link transmits command signals to, and receives monitoring signals from, the motorized device, and
varying a position, pressure, or duration of touch on the input transducer to produced nuanced control of throttle or steering in the motorized device.

14. A non-transitory machine-readable storage medium programmed with instructions and data comprising:
instructions for initiating and maintaining wireless communication between a control glove and a motorized device,
instructions for translating input from an input transducer on the control glove to commands controlling functions of a motorized device,
instructions for receiving a status signal from a monitor on the motorized device and comparing the status signal to a stored threshold,
data defining a threshold of the status signal corresponding to a functionally important change in status of the motorized device,
instructions for causing an output transducer to issue an alert if the status signal crosses the threshold,
data keying a unique motorized device to a unique control glove, effectively preventing neighboring users from transmitting to or receiving from each other's devices, and
instructions for identifying a signal change warranting a safety shut-off.

15. The non-transitory storage medium of claim 14, where the motorized device comprises:
a surfboard,
a paddleboard,
a windsurfer,
a skateboard,
a snowboard, or
a remote-controlled miniature vehicle, vessel, or aircraft.

16. The non-transitory storage medium of claim 14, where the alert corresponds to low power reserves in a power source.

17. The non-transitory storage medium of claim 14, further comprising instructions for sending or accepting an override signal transferring control of the motorized device to another user.

18. The non-transitory storage medium of claim 14, further comprising instructions for changing the keying data to un-key the control glove from the unique motorized device and key it to a different motorized device.

19. The non-transitory storage medium of claim 14, further comprising instructions for customizing the glove's commands and alerts.

20. The non-transitory storage medium of claim 14, further comprising instructions for customizing the sensitivity of the motorized device to small changes in input from the glove.
